(19) United States
(12) Patent Application Publication
(10) Pub. No.: US 2010/0083694 A1
(43) Pub. Date: Apr. 8, 2010

(54) Evaporator

(75) Inventors: Motoyuki Takagi, Oyama-shi (JP); Naohisa Higashiyama, Oyama-shi (JP); Hokuto Mine, Oyama-shi (JP)

Correspondence Address: EDWARDS ANGELL PALMER & DODGE LLP, P.O. BOX 55874, BOSTON, MA, 02205, US

(73) Assignee: Showa Denko K.K., Tokyo (JP)

(21) Appl. No.: 12/588,157

(22) Filed: Oct. 6, 2009

(30) Foreign Application Priority Data
Oct. 7, 2008 (JP) 2008-260438

(51) Int. Cl. F25B 39/02; B60H 1/32; F28F 9/00; F28F 1/10

(52) U.S. Cl. 62/515; 165/151; 165/153; 165/42; 62/244; 62/519

(57) ABSTRACT

Each heat exchange tube of an evaporator is composed of two press-worked rectangular metal plates joined together in a stacked condition. The metal plates of the heat exchange tube are swelled outward whereby at least one refrigerant flow space extending in the vertical direction and having opened upper and lower ends is provided in the heat exchange tube. Insertion portions to be inserted into header sections of header tanks of the evaporator via tube insertion holes are provided on upper and lower end portions of each heat exchange tube at positions corresponding to the refrigerant flow space. A concave portion is formed in each of the insertion portions, excluding opposite ends thereof with respect to the front-rear direction, of the upper and lower end portions of each heat exchange tube, the concave portion being concaved inward with respect to a longitudinal direction of the heat exchange tube.

### BACKGROUND OF THE INVENTION

The present invention relates to an evaporator suitable for use in a car air conditioner, which is a refrigeration cycle to be mounted on an automobile, for example.

In this specification and appended claims, the downstream side (a direction represented by arrow X in FIGS. 1, 2 and 10) of an air flow through air-passing clearances between adjacent heat exchange tubes will be referred to as the “front,” and the opposite side as the “rear.” Further, the upper and lower sides of FIGS. 1, 2, and 10 will be referred to as “upper” and “lower,” respectively.

Recently, the present applicant has proposed an evaporator for a car air conditioner which satisfies the requirements for reduction in size and weight and higher performance (refer to Japanese Patent Application Laid-Open (kokai) No. 2008-20098). The evaporator includes a pair of header tanks disposed apart from each other in the vertical direction, and a plurality of flat heat exchange tubes formed of an aluminum extrudate and disposed between the two header tanks such that their width direction coincides with the front-rear direction and they are spaced from one another in the longitudinal direction of the header tanks. The upper header tank includes a refrigerant inlet header section and a refrigerant outlet header section juxtaposed in the front-rear direction and integrated with each other. The lower header tank includes a first intermediate header section provided so as to face the refrigerant inlet header section, and a second intermediate header section provided rearward of the first intermediate header section so as to face the refrigerant outlet header section and integrated with the first intermediate header section. Each header section of each header tank has a convex portion which projects toward the other header tank and extends over the entire length of the header section. The convex portion has front and rear side walls which incline inward with respect to the width direction of the heat exchange tubes, toward the other header tank, and a flat connection wall which connects the distal ends of the front and rear side walls together. Tube insertion holes, into which end portions of the heat exchange tubes are inserted, are formed in the convex portion such that they extend from the front side wall to the rear side wall of the convex portion. A heat exchange tube group composed of a plurality of heat exchange tubes disposed at predetermined intervals in the longitudinal direction of the header tanks is provided between each of the header sections of the upper header tank and the corresponding header section of the lower header tank, and is brazed to the two header tanks in a state in which opposite end portions of the heat exchange tubes of each heat exchange tube group are inserted into the corresponding header sections of the two header tanks through the tube insertion holes. The ends of insertion portions of the heat exchange tubes inserted into the corresponding header tanks through the tube insertion holes are flat and extend horizontally.

Incidentally, in a car air conditioner, the temperature of air on the outlet side of an evaporator (the temperature of discharged air) is detected, and a compressor is controlled on the basis of the detected temperature of the discharged air such that the compressor is turned on and off repeatedly or periodically. When the compressor is turned off, of the two-phase refrigerant (mixture of vapor-phase refrigerant and liquid-phase refrigerant) remaining in the refrigerant inlet header section and the refrigerant outlet header section of the upper header tank, the liquid-phase refrigerant flows into refrigerant flow channels of the heat exchange tubes due to gravitational force, to thereby prevent a sharp increase in the temperature of the discharged air, which sharp increase would otherwise occur when the compressor is turned off.

However, the evaporator disclosed in the above-mentioned publication has the following drawbacks. That is, in the disclosed evaporator, each header section of each header tank has a convex portion which projects toward the other header tank and extends over the entire length of the header section. The convex portion has front and rear side walls which incline inward with respect to the width direction of the heat exchange tubes, toward the other header tank, and a flat connection wall which connects the distal ends of the front and rear side walls together. Tube insertion holes, into which end portions of the heat exchange tubes are inserted, are formed in the convex portion such that they extend from the front side wall to the rear side wall of the convex portion. The ends of insertion portions of the heat exchange tubes inserted into the corresponding header tanks through the tube insertion holes are flat and extend horizontally. Therefore, the maximum vertical distance between the end of the insertion portion of each heat exchange tube and the inner surface of the connection wall of the convex portion of the refrigerant inlet header section or the refrigerant outlet header section is relatively large. This relatively large maximum distance decreases the amount of the liquid-phase refrigerant which flows into refrigerant flow channels of the heat exchange tubes of each heat exchange tube group (the liquid-phase refrigerant being a portion of the two-phase refrigerant remaining in the refrigerant inlet header section and the refrigerant outlet header section of the upper header tank). Therefore, the effect of preventing a sharp increase in the temperature of the discharged air, which sharp increase would otherwise occur when the compressor is turned off, cannot be attained satisfactorily in some cases.

Further, the ends of insertion portions of the heat exchange tubes are flat and extend horizontally, and the maximum vertical distance between the end of the insertion portion of each heat exchange tube and the inner surface of the connection wall of the convex portion of the refrigerant inlet header section or the refrigerant outlet header section is relatively large. Therefore, passage resistances within the refrigerant inlet header section and the refrigerant outlet header section increase, so that performance may drop. In particular, the increased passage resistance within the refrigerant outlet header section may result in a considerable drop in performance because the ratio of vapor-phase refrigerant present within the refrigerant outlet header section is high.

### SUMMARY OF THE INVENTION

An object of the present invention is to solve the above problem and to provide an evaporator which can prevent a sharp increase in the temperature of the discharged air, which sharp increase would otherwise occur when the compressor is turned off, and can prevent an increase in passage resistances within the header sections.

To fulfill the above object, the present invention comprises the following modes.

1) An evaporator comprising a pair of header tanks disposed apart from each other in a vertical direction, and a plurality of flat heat exchange tubes disposed between the two header tanks such that the width direction of the heat exchange tubes coincides with a front-rear direction and the heat exchange tubes are spaced from one another in a longitudinal direction of the header tanks, each of the header tanks including at least one header section which extends in the longitudinal direction of the header tanks, and opposite end portions of the heat exchange tubes being inserted into respective tube insertion holes formed in the header sections of the header tanks and brazed to the header tanks, wherein

each heat exchange tube is composed of two press-worked rectangular metal plates joined together in a stacked condition;

each heat exchange tube includes at least one refrigerant flow space which extends in the vertical direction and whose upper and lower ends are opened, the refrigerant flow space being formed by means of swelling outward at least one of the metal plates of the heat exchange tube;

insertion portions to be inserted into the header sections of the header tanks via the tube insertion holes are provided on upper and lower end portions of each heat exchange tube at positions corresponding to the refrigerant flow space; and

a concave portion is formed in the insertion portion, excluding opposite ends thereof with respect to the front-rear direction, of at least the upper end portion of each heat exchange tube, the concave portion being concaved inward with respect to a longitudinal direction of the heat exchange tube.

2) An evaporator according to par. 1), wherein the header section of at least the upper header tank includes a convex portion which projects toward the other header tank and extends over the entire length of the upper header tank, and the convex portion has tube insertion holes into which the insertion portions of the heat exchange tubes are inserted.

3) An evaporator according to par. 2), wherein the convex portion of the header section of the upper header tank includes front and rear side walls which incline inward with respect to the width direction of the heat exchange tube toward the other header tank, and a flat connection wall which connects together distal ends of the front and rear side walls; and the tube insertion holes extend from the front side wall to the rear side wall of the convex portion.

4) An evaporator according to par. 3), wherein the concave portion of each insertion portion of each heat exchange tube includes front and rear side portions which incline inward with respect to the width direction of the heat exchange tube toward the other end of the heat exchange tube, and a straight bottom side portion which connects together inner end portions of the front and rear side portions with respect to the longitudinal direction of the heat exchange tube and which expends in parallel to an inner surface of the connection wall of the convex portion of the corresponding header section.

5) An evaporator according to par. 4), wherein the maximum distance, as measured in the vertical direction, between the bottom side portion of the concave portion of each insertion portion of each heat exchange tube and the inner surface of the connection wall of the convex portion of the corresponding header section is 2.0 mm or less.

6) An evaporator according to par. 1), wherein each header tank includes a plurality of header sections juxtaposed in the front-rear direction; each heat exchange tube includes a plurality of refrigerant flow spaces separated from one another in the front-rear direction, the number of the refrigerant flow spaces being equal to the number of the header sections; and positioning portions which come into engagement with outer surfaces of the upper and lower header tanks so as to position the upper and lower end portions of each heat exchange tube are provided on the upper and lower ends of the heat exchange tube to be located between the adjacent refrigerant flow spaces.

7) An evaporator according to par. 1), wherein each header tank includes a single header section; each heat exchange tube includes a singe refrigerant flow space; and positioning portions which come into engagement with outer surfaces of the upper and lower header tanks so as to position the upper and lower end portions of each heat exchange tube are provided on the upper and lower ends of the heat exchange tube to be located on the front and rear sides, respectively, of the refrigerant flow space.

8) An evaporator according to par. 1), wherein each of the two metal plates of each heat exchange tube has a thickness of 0.25 mm or less.

9) An evaporator according to par. 1), wherein a corrugated inner fin is disposed within the refrigerant flow space of each heat exchange tube and brazed to the two metal plates, and the inner fin has a thickness of 0.1 mm or less.

10) An evaporator according to par. 1), wherein the upper header tank includes a refrigerant inlet header section having a refrigerant inlet at one end thereof, and refrigerant flows within the refrigerant inlet header section from a refrigerant-inlet-side end toward the other end.

11) An evaporator according to par. 1), wherein the upper header tank includes a refrigerant inlet header section having a refrigerant inlet at one end thereof; the interior of the refrigerant inlet header section is divided by means of a partition member into an upper space into which refrigerant flows via the refrigerant inlet and an lower space which the heat exchange tubes face; the upper and lower spaces of the refrigerant inlet header section are connected with each other via a communication portion at an end opposite the refrigerant inlet; and, in the upper space, the refrigerant flows from a refrigerant-inlet-side end toward the other end, and, in the lower space, the refrigerant flows in a direction opposite the flow direction of the refrigerant within the upper space.

According to the evaporators of par. 1), each heat exchange tube is composed of two press-worked rectangular metal plates joined together in a stacked condition; each heat exchange tube includes at least one refrigerant flow space which extends in the vertical direction and whose upper and lower ends are opened, the refrigerant flow space being formed by means of swelling outward at least one of the metal plates of the heat exchange tube; insertion portions to be inserted into the header sections of the header tanks via the tube insertion holes are provided on upper and lower end portions of each heat exchange tube at positions corresponding to the refrigerant flow space; and a concave portion is formed in the insertion portion, excluding opposite ends thereof with respect to the front-rear direction, of at least the upper end portion of each heat exchange tube, the concave portion being concaved inward with respect to the longitudinal direction of the heat exchange tube. Thus, the maximum distance, as measured in the vertical direction, between the distal end of the insertion portion of the upper end portion of each heat exchange tube and the inner surface of the wall of the header section of the upper header tank, the wall having the tube insertion holes formed therein, can be reduced as compared with the evaporator disclosed in the above-mentioned publication. Accordingly, when a compressor is turned off, of the two-phase refrigerant (mixture of vapor-phase refrigerant and liquid-phase refrigerant) remaining in the header section of the upper header tank, a relatively large amount of the liquid-phase refrigerant flows into refrigerant flow channels of the heat exchange tubes, to thereby prevent a sharp increase in the temperature of the discharged air, which sharp increase would otherwise occur when the compressor is turned off.

Also, since the cross sectional area of the refrigerant flow channel within the header section of at least the upper header tank can be increased, a drop in performance due to an increase in the passage resistance within the header section of the upper header tank can be prevented.

Moreover, since each heat exchange tube is formed by joining two press-worked rectangular metal plates together, before the metal plates are joined together, a cutout portion can be formed, by means of press work, at least an upper end portion of each metal plate so as to form the concave portion at the upper end portion. Accordingly, the work of forming a concave portion in the insertion portion, excluding opposite ends thereof with respect to the front-rear direction, of at least the upper end portion of each heat exchange tube, can be performed more simply, as compared with the work which is employed in manufacture of the evaporator disclosed in the above-mentioned publication so as to form a concave portion in each end portion of each heat exchange tube formed of an extrudate.

In the case where the header section of at least the upper header tank includes a convex portion which projects toward the other header tank and extends over the entire length of the upper header tank, and the convex portion has tube insertion holes into which the insertion portions of the heat exchange tubes are inserted as in the evaporators according to pars. 2) and 3), a relatively large amount of two-phase refrigerant stagnates within the header section of the upper header tank. Therefore, in the evaporator configured as described in par. 1), the amount of the liquid-phase refrigerant which is a portion of the two-phase refrigerant remaining in the header section of the upper header tank and which flows into refrigerant flow channels of the heat exchange tubes becomes relatively large, to thereby effectively prevent a sharp increase in the temperature of the discharged air, which sharp increase would otherwise occur when the compressor is turned off.

Further, since the convex portion which projects toward the other header tank is formed on the header section of the upper header tank over the entire length of the upper header tank, the withstanding pressure of the upper header tank increases.

According to the evaporator of par. 4), the cross sectional area of the refrigerant flow channel within the header section of the upper header tank can be maximized.

The evaporator of par. 5) can minimize the amount of the liquid-phase refrigerant which does not flow from the header section of the upper header tank into the refrigerant flow channels of the heat exchange tubes when the compressor is turned off.

According to the evaporators of pars. 6) and 7), an insertion length over which each insertion portion of each heat exchange tube is inserted into the corresponding header tank through the corresponding tube insertion hole of the header section thereof can be made constant.

According to the evaporator of par. 7), the number of parts can be made smaller as compared with the evaporator disclosed in the above-mentioned publication.

According to the evaporator of par. 8), the weight of the heat exchange tubes can be reduced.

According to the evaporator of par. 9), the withstand pressure of the heat exchange tubes can be increased.

The evaporator according to par. 10) achieves the following effect. In the evaporator in which the upper header tank includes a refrigerant inlet header section having a refrigerant inlet at one end thereof and refrigerant flows within the refrigerant inlet header section from a refrigerant-inlet-side end toward the other end, the following problem occurs if the distal end of the upper insertion portion of each heat exchange tube is flat and extends horizontally. That is, when the flow rate of the refrigerant is high, the refrigerant having flowed from the refrigerant inlet tends to flow to the end portion opposite the refrigerant inlet due to inertia, so that the amount of the refrigerant flowing into heat exchange tubes disposed on the side toward the refrigerant inlet decreases, and the amount of the refrigerant flowing into heat exchange tubes disposed on the side toward the end portion opposite the refrigerant inlet increases. Consequently, the divided flow of the refrigerant into all the heat exchange tubes connected to the refrigerant inlet header section becomes non-uniform. However, in the case where, as in the evaporator according par. 1), a concave portion is formed in the insertion portion, excluding opposite ends thereof with respect to the front-rear direction, of at least the upper end portion of each heat exchange tube, the concave portion being concaved inward with respect to the longitudinal direction of the heat exchange tube, the cross sectional area of the refrigerant flow channel within the header section increases, whereby the flow velocity of the refrigerant decreases. Thus, it becomes possible to prevent the refrigerant having flowed from the refrigerant inlet from flowing to the end portion opposite the refrigerant inlet due to inertia. Accordingly, the divided flow of the refrigerant into all the heat exchange tubes connected to the refrigerant inlet header section can be made uniform.

The evaporator according to par. 11) achieves the following effect. In the evaporator—in which the upper header tank includes a refrigerant inlet header section having a refrigerant inlet at one end thereof; the interior of the refrigerant inlet header section is divided by means of a partition member into an upper space into which refrigerant flows via the refrigerant inlet and an lower space which the heat exchange tubes face; the upper and lower spaces of the refrigerant inlet header section are connected with each other via a communication portion at an end opposite the refrigerant inlet; and, in the upper space, the refrigerant flows from a refrigerant-inlet-side end toward the other end, and, in the lower space, the refrigerant flows in a direction opposite the flow direction of the refrigerant within the upper space—the following problem occurs if the distal end of the upper insertion portion of each heat exchange tube is flat and extends horizontally, as in the evaporator disclosed in the above-mentioned publication. That is, in the case where the flow rate of the refrigerant is high, when the refrigerant having flowed from the refrigerant inlet into the upper space of the refrigerant inlet header section flows into the lower space via the communication portion, due to the downward flow component, the refrigerant tends to flow downward, whereby a large amount of refrigerant flows into heat exchange tubes on the side toward the communication portion. Simultaneously, the refrigerant having flowed downward collides with portions of the heat exchange tubes projecting into the header section and bounds (i.e., deflects) upward. As a result, it becomes difficult for the refrigerant to flow into heat exchange tubes disposed at an intermediate portion of the refrigerant inlet header section with respect to the longitudinal direction thereof, and becomes easy for the refrigerant to flow toward the end portion on the side toward the refrigerant inlet (the end portion opposite the communication portion), so that the refrigerant also flows in a large amount into heat exchange tubes disposed on the side toward the refrigerant inlet. Consequently, the divided flow of the refrigerant into all the heat exchange tubes connected to the refrigerant inlet header section becomes non-uniform. However, in the case where, as in the evaporator according par. 1), a concave portion is formed in the insertion portion, excluding opposite ends thereof with respect to the front-rear direction, of at least the upper end portion of each heat exchange tube, the concave portion being concaved inward with respect to the longitudinal direction of the heat exchange tube, the concave portion suppresses the upward bounding (deflection) of the refrigerant, which occurs when the refrigerant having flowed from the refrigerant inlet into the upper space of the refrigerant inlet header section flows into the lower space via the communication portion. Accordingly, the amount of the refrigerant flowing into the heat exchange tubes disposed at the intermediate portion of the refrigerant inlet header section with respect to the longitudinal direction thereof increases, whereby the divided flow of the refrigerant into all the heat exchange tubes connected to the refrigerant inlet header section can be made uniform.

### BRIEF DESCRIPTION OF THE DRAWINGS

FIG. 1 is a partially cut-away perspective view showing the overall structure of an embodiment of an evaporator according to the present invention;

FIG. 2 is a partially omitted enlarged sectional view taken along line A-A of FIG. 1;

FIG. 3 is an exploded perspective view of a first header tank of the evaporator of FIG. 1;

FIG. 4 is an exploded perspective view showing an upper end portion of a heat exchange tube of the evaporator of FIG. 1 and a portion of a first member of the first header tank;

FIG. 5 is an enlarged sectional view taken along line B-B of FIG. 2;

FIG. 6 is an exploded perspective view of a second header tank of the evaporator of FIG. 1;

FIG. 7 is an exploded perspective view showing a lower end portion of a heat exchange tube of the evaporator of FIG. 1 and a portion of a first member of the second header tank;

FIG. 8 is an enlarged sectional view taken along line C-C of FIG. 2;

FIG. 9 is a partially omitted enlarged sectional view taken along line D-D of FIG. 2;

FIG. 10 is a view corresponding to FIG. 2 and showing another embodiment of the evaporator according to the present invention; and

FIG. 11 is a partially omitted enlarged sectional view taken along line E-E of FIG. 10.

### DESCRIPTION OF THE PREFERRED EMBODIMENTS

Embodiments of the present invention will next be described with reference to the drawings.

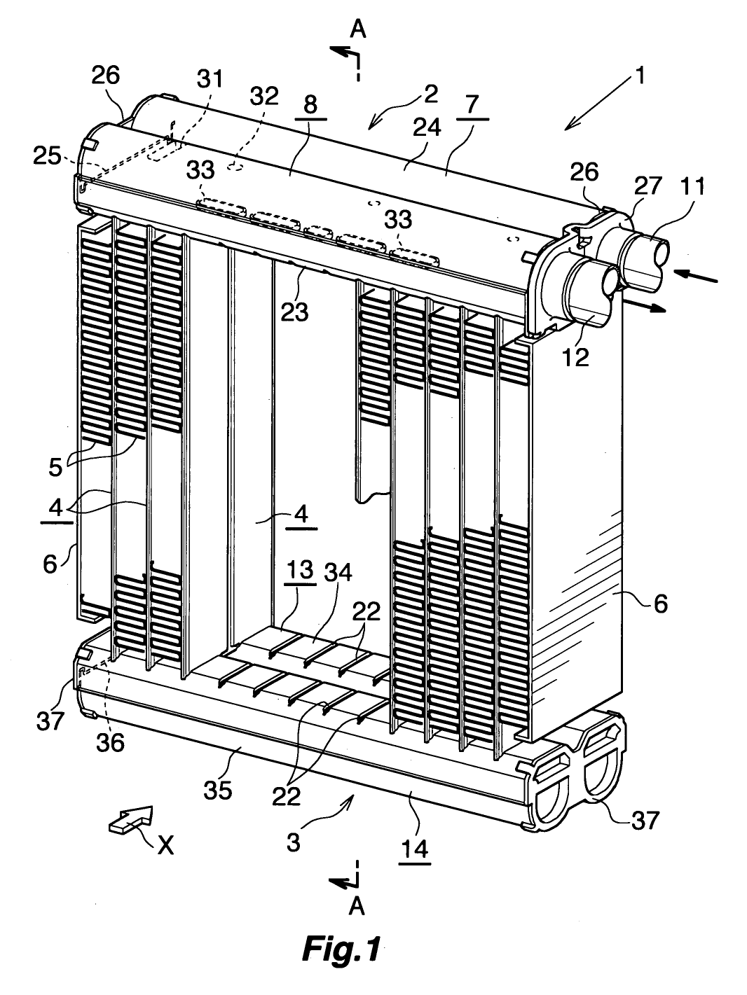

In the following description, the term “aluminum” encompasses aluminum alloys in addition to pure aluminum. Further, in the following description, the left-hand and right-hand sides of FIG. 1 will be referred to as “left” and “right,” respectively.

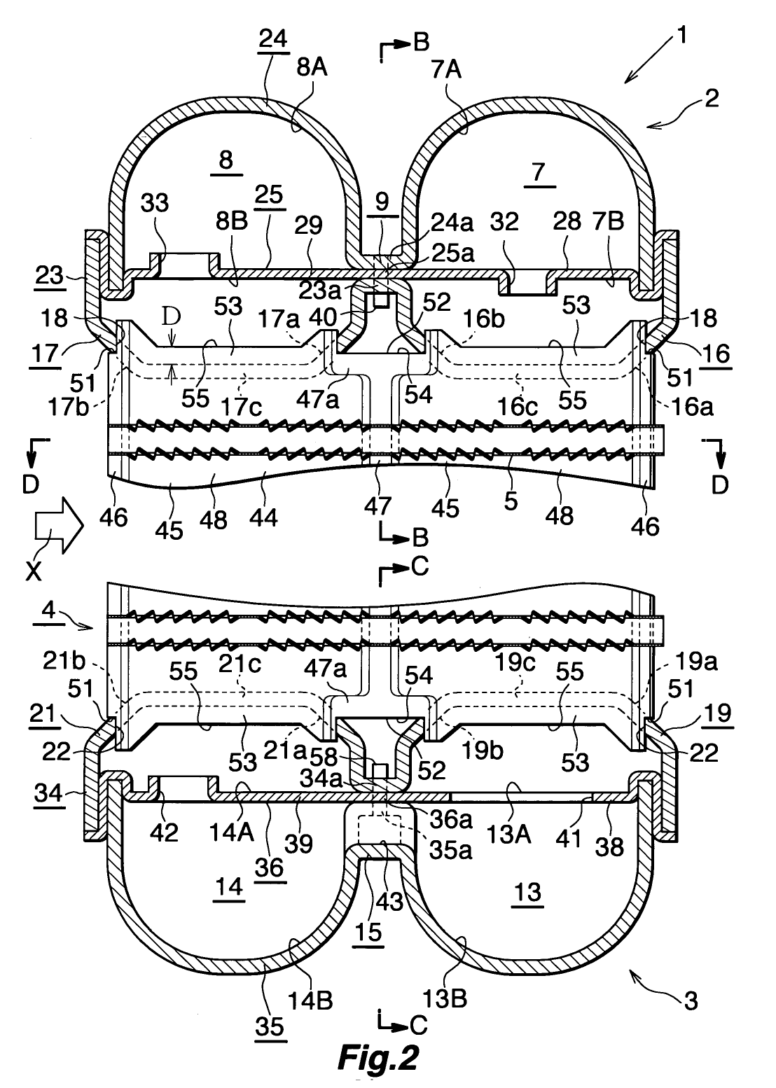

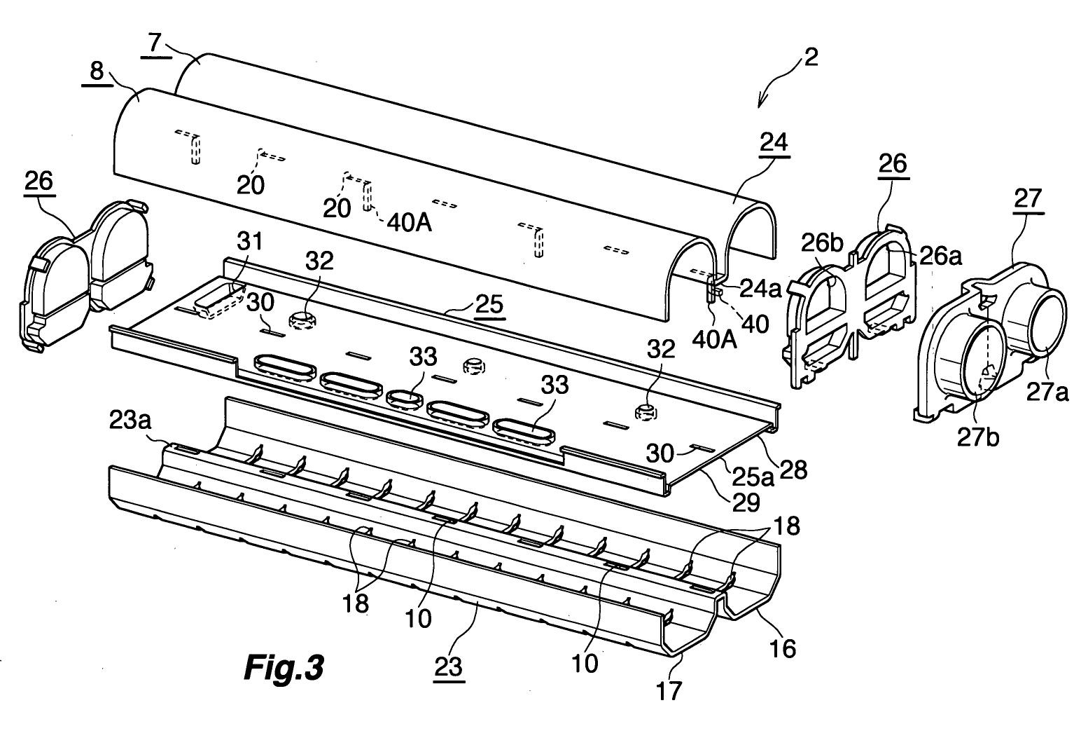

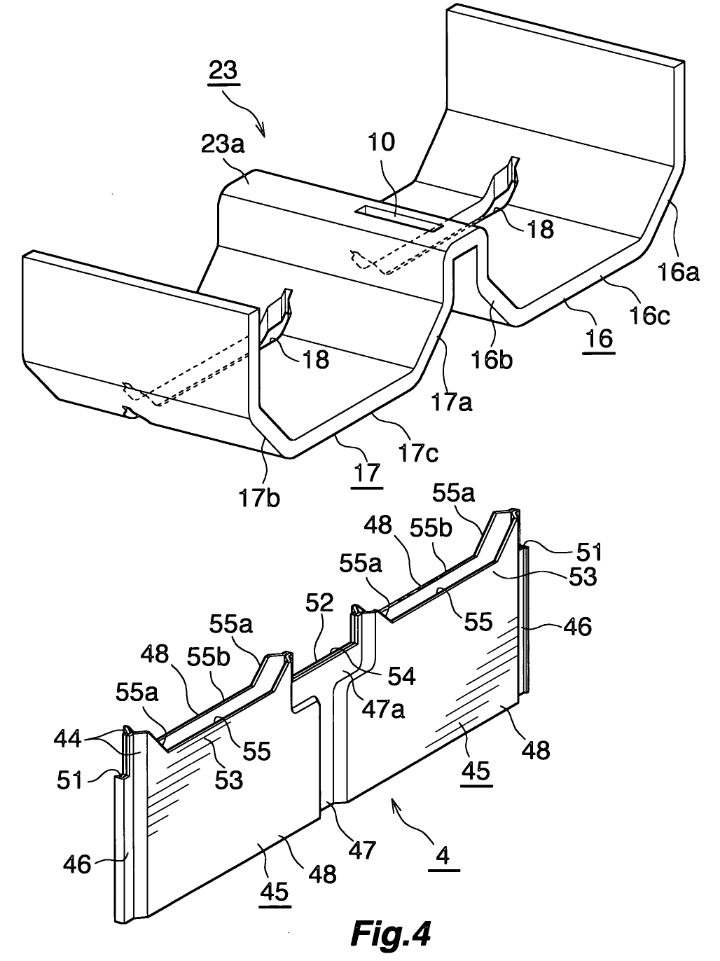

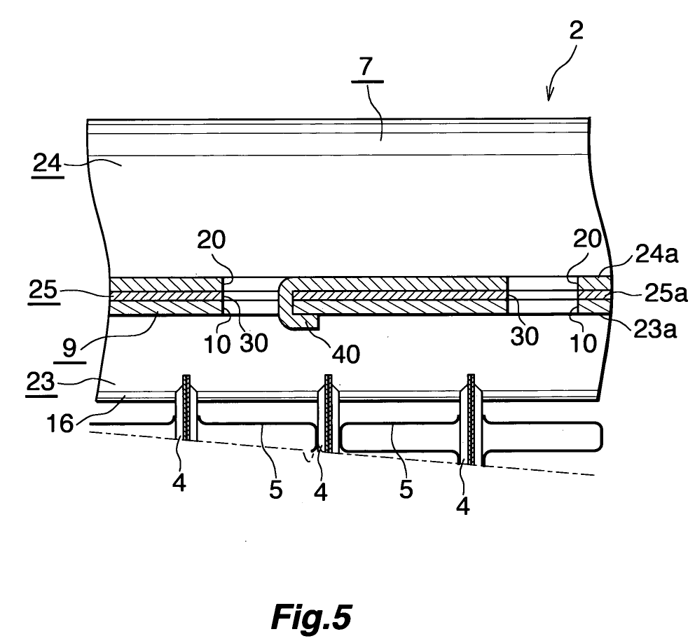

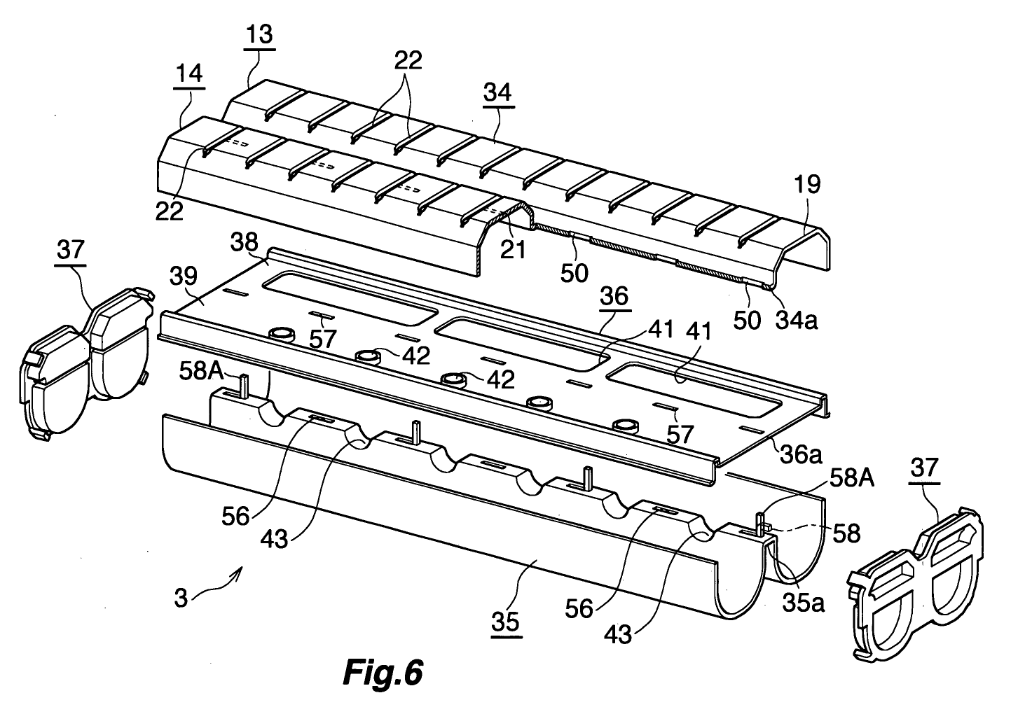

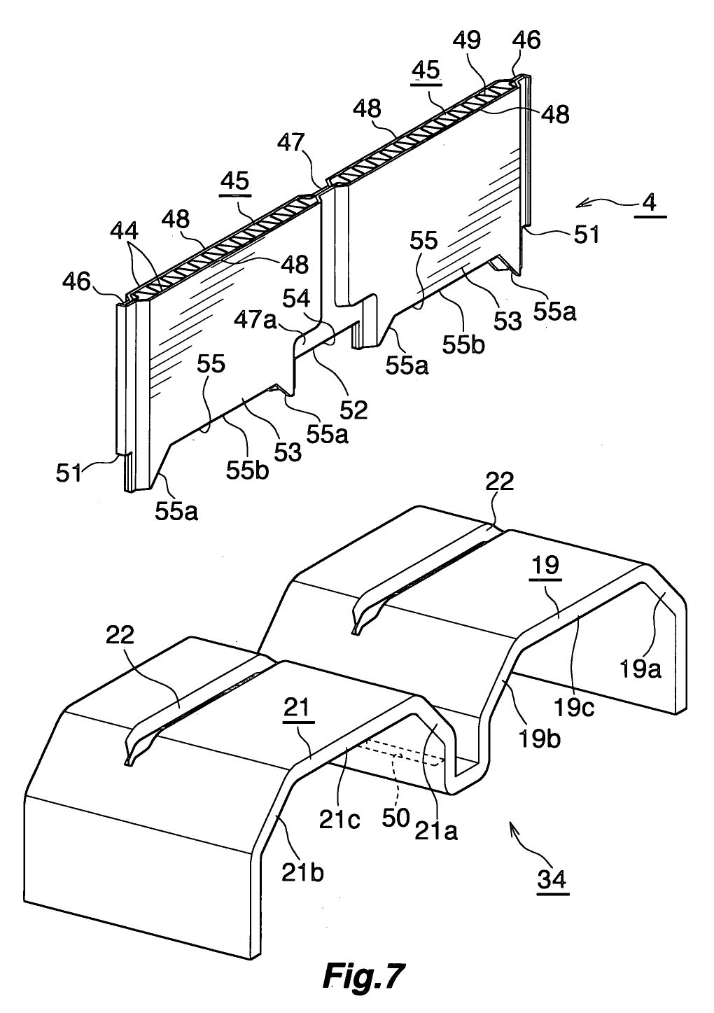

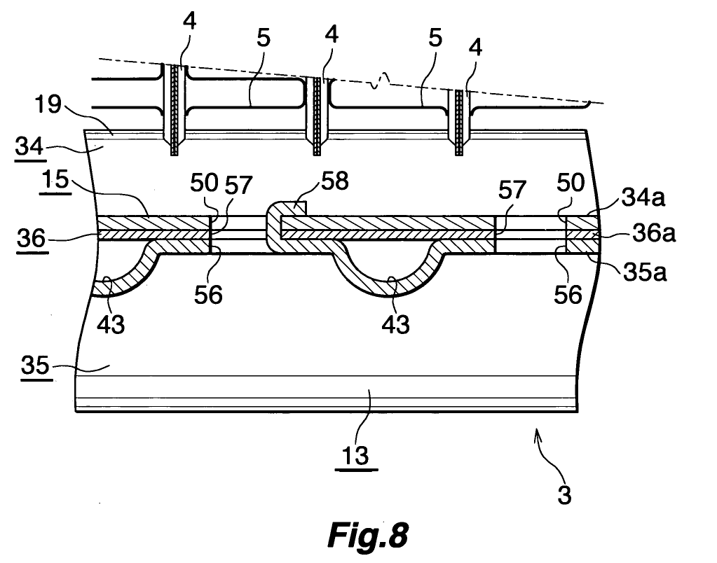

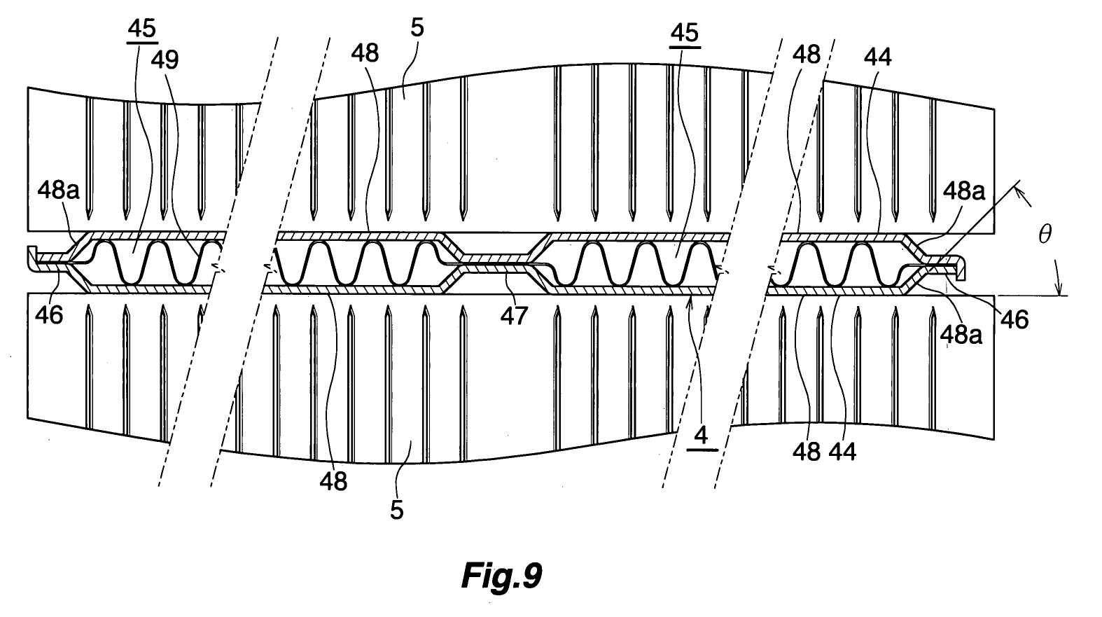

FIG. 1 shows the overall configuration of an evaporator, and FIGS. 2 to 9 show the configurations of essential portions of the evaporator.

As shown in FIGS. 1 and 2, an evaporator 1 includes a first header tank 2 and a second header tank 3 formed of aluminum and disposed apart from each other in the vertical direction such that they extend in the left-right direction; a plurality of flat heat exchange tubes 4 formed of aluminum and disposed between the two header tanks 2 and 3 such that their width direction coincides with the front-rear direction and they are spaced from one another in the left-right direction (the longitudinal direction of the header tanks 2 and 3); corrugated fins 5 made of aluminum, disposed in air-passing clearances between the adjacent heat exchange tubes 4 and externally of the left- and right-end heat exchange tubes 4, and brazed to the heat exchange tubes 4; and side plates 6 made of aluminum, disposed externally of the left- and right-end corrugated fins 5 and brazed to the corrugated fins 5.

The first header tank 2 includes a refrigerant inlet header section 7 located on the front side (downstream side with respect to the air flow direction) and extending in the left-right direction; a refrigerant outlet header section 8 located on the rear side (upstream side with respect to the air flow direction) and extending in the left-right direction; and a connection section 9 which integrally connects the header sections 7 and 8 together. A refrigerant inlet pipe 11 made of aluminum is connected to the refrigerant inlet header section 7 of the first header tank 2. Similarly, a refrigerant outlet pipe 12 made of aluminum is connected to the refrigerant outlet header section 8. The second header tank 3 includes a first intermediate header section 13 located on the front side and extending in the left-right direction; a second intermediate header section 14 located on the rear side and extending in the left-right direction; and a connection section 15 which integrally connects the header sections 13 and 14 together. The first header thank 2 and the second header tank 3 are identical in the transverse sectional shape of the circumferential wall, and are disposed in a mirror-image relation.

As shown in FIGS. 2 to 5, at lower portions (portions facing the second header tank 3) of the refrigerant inlet header section 7 and the refrigerant outlet header section 8 of the first header tank 2, convex portions 16 and 17 which project downward (toward the second header tank 3) are formed over the entire length of the first header tank 2. The convex portion 16 of the refrigerant inlet header section 7 has front and rear side walls 16a and 16b which incline inward with respect to the front-rear direction (inward with respect to the width direction of the heat exchange tubes 4) toward the lower side (toward the second header tank 3), and a horizontal flat connection wall 16c which connects the distal ends (lower ends) of the front and rear side walls 16a and 16b together. Similarly, the convex portion 17 of the refrigerant outlet header section 8 has front and rear side walls 17a and 17b which incline inward with respect to the front-rear direction toward the lower side, and a horizontal flat connection wall 17c which connects the distal ends of the front and rear side walls 17a and 17b together. A plurality of tube insertion holes 18, which are elongated in the front-rear direction and into which upper end portions of the heat exchange tubes 4 are inserted, are formed in the refrigerant inlet header section 7 and the refrigerant outlet header section 8 such that they extend from the front side walls 16a and 17a to the rear side walls 16b and 17b, respectively, of the convex portions 16 and 17. The tube insertion holes 18 of the refrigerant inlet header section 7 and those of the refrigerant outlet header section 8 are located at the same positions with respect to the left-right direction.

At upper portions (portions facing the first header tank 2) of the first intermediate header section 13 and the second intermediate header section 14 of the second header tank 3, convex portions 19 and 21 which project upward (toward the first header tank 2) are formed over the entire length of the second header tank 3. The convex portion 19 of the first intermediate header section 13 has front and rear side walls 19a and 19b which incline inward with respect to the front-rear direction (inward with respect to the width direction of the heat exchange tubes 4) toward the upper side (toward the first header tank 2), and a horizontal flat connection wall 19c which connects the distal ends (upper ends) of the front and rear side walls 19a and 19b together. Similarly, the convex portion 21 of the second intermediate header section 14 has front and rear side walls 21a and 21b which incline inward with respect to the front-rear direction toward the upper side, and a horizontal flat connection wall 21c which connects the distal ends (upper ends) of the front and rear side walls 21a and 21b together. A plurality of tube insertion holes 22, which are elongated in the front-rear direction and into which lower end portions of the heat exchange tubes 4 are inserted, are formed in the first intermediate header section 13 and the second intermediate header section 14 such that they extend from the front side walls 19a and 21a to the rear side walls 19b and 21b, respectively, of the convex portions 19 and 21.

The first header tank 2 is composed of a plate-like first member 23 which is formed, through press work, from an aluminum brazing sheet having a brazing material layer on each of opposite sides thereof and to which all the heat exchange tubes 4 are connected; a second member 24 which is formed, through press work, from an aluminum brazing sheet having a brazing material layer on each of opposite sides thereof and which covers the upper side (the side opposite the heat exchange tubes 4) of the first member 23; a flat partition portion forming plate 25 which is formed, through press work, from an aluminum brazing sheet having a brazing material layer on each of opposite sides thereof or an aluminum bare material and which is interposed between the first member 23 and the second member 24 and is brazed to the first member 23 and the second member 24; left and right end members 26 which are formed, through press work, from an aluminum brazing sheet having a brazing material layer on each of opposite sides thereof and which are brazed to left ends and right ends, respectively, of the first member 23, the second member 24, and the partition portion forming plate 25; and a joint plate 27 which is formed of aluminum, extends in the front-rear direction, and is brazed to the outer surface of the right end member 26 such that the joint plate 27 extends across the refrigerant inlet header section 7 and the refrigerant outlet header section 8. The refrigerant inlet pipe 11 and the refrigerant outlet pipe 12 are connected to the joint plate 27. Notably, the joint plate 27 is formed from an aluminum bare material through press work.

The first member 23 forms the convex portions 16 and 17 of the refrigerant inlet header section 7 and the refrigerant outlet header section 8, lower portions of the vertical front and rear side walls of the refrigerant inlet header section 7 and the refrigerant outlet header section 8, and a lower portion of the connection section 9. A plurality of drain through holes 10 elongated in the left-right direction are formed in a flat portion 23a of the first member 23, which forms the lower portion of the connection section 9, such that the drain through holes 10 are spaced from one another in the left-right direction. The second member 24 forms a top wall having an arcuate transverse cross section and connecting together upper end portions of the front and rear side walls of the refrigerant inlet header section 7 and the refrigerant outlet header section 8, upper portions of the front and rear side walls of the refrigerant inlet header section 7 and the refrigerant outlet header section 8, and an upper portion of the connection section 9. A plurality of drain through holes 20 elongated in the left-right direction are formed in a flat portion 24a of the second member 24, which forms the upper portion of the connection section 9, at positions corresponding to the positions of the drain through holes 10 of the first member 23.

The partition portion forming plate 25 forms a front partition portion 28 (partition member) which divides the interior of the refrigerant inlet header section 7 into upper and lower spaces 7A and 7B, a rear partition portion 29 which divides the interior of the refrigerant outlet header section 8 into upper and lower spaces 8A and 8B, and an intermediate portion (with respect to the vertical direction) of the connection section 9. A communication hole 31 (communication portion) for establishing communication between the upper and lower spaces 7A and 7B within the refrigerant inlet header section 7 is formed in the front partition portion 28 of the partition portion forming plate 25 at a position located leftward of the heat exchange tube 4 disposed at the left end. A plurality of circular communication holes 32 for establishing communication between the upper and lower spaces 7A and 7B of the refrigerant inlet header section 7 are formed in an intermediate portion (with respect to the front-rear direction) of the front partition portion 28 of the partition portion forming plate 25 at predetermined intervals in the left-right direction. Further, a plurality of oblong communication holes 33 elongated in the left-right direction and adapted to establish communication between the upper and lower spaces 8A and 8B of the refrigerant outlet header section 8 are formed, at predetermined intervals in the left-right direction, in a rear portion of the rear partition portion 29 of the partition portion forming plate 25, excluding left and right end portions of the rear portion. The length of the oblong communication hole 33 in the central portion is shorter than those of the remaining oblong communication hole 33. Further, a plurality of drain through holes 30 elongated in the left-right direction are formed in a flat portion 25a of the partition portion forming plate 25, which forms the intermediate portion (with respect to the vertical direction) of the connection section 9, at positions corresponding to the positions of the drain through holes 10 and 20 of the first member 23 and the second member 24.

Provisional fixing claws 40, which are inserted into the drain through holes 30 and 10 of the partition portion forming plate 25 and the first member 23 from above, are integrally formed on the flat portion 24a of the second member 24 at one ends (right ends in the present embodiment) of at least a portion of the drain through holes 20. Distal end portions of the provisional fixing claws 40 are brazed to the partition portion forming plate 25 and the first member 23 in a state in which the distal end portions are bent rightward and bought into engagement with the lower surface of the first member 23. Before the first member 23, the second member 24, and the partition portion forming plate 25 are assembled together, the provisional fixing claws 40 extend straight. The first member 23, the second member 24, and the partition portion forming plate 25 are provisionally fixed together by means of assembling these members and bending the distal end portions of the provisional fixing claws 40. The straight provisional fixing claws before being bent are denoted by 40A.

The left end member 26 closes the left end openings of the refrigerant inlet header section 7 and the refrigerant outlet header section 8, and the right end member 26 closes the right end openings of the refrigerant inlet header section 7 and the refrigerant outlet header section 8. A refrigerant inlet 26a is formed in a portion (facing the upper space 7A) of a portion of the right end member 26 which portion closes the right end opening of the refrigerant inlet header section 7, and a refrigerant outlet 26b is formed in a portion (facing the upper space 8A) of a portion of the right end member 26 which portion closes the right end opening of the refrigerant outlet header section 8. The joint plate 27 has refrigerant passages 27a and 27b which communicate with the refrigerant inlet 26a and the refrigerant outlet 26b of the right end member 26.

As shown in FIGS. 2 and 6 to 8, the second header tank 3 is composed of a plate-like first member 34 which is formed, through press work, from an aluminum brazing sheet having a brazing material layer on each of opposite sides thereof and to which all the heat exchange tubes 4 are connected; a second member 35 which is formed, through press work, from an aluminum brazing sheet having a brazing material layer on each of opposite sides thereof and which covers the lower side (the side opposite the heat exchange tubes 4) of the first member 34; a flat partition portion forming plate 36 which is formed, through press work, from an aluminum brazing sheet having a brazing material layer on each of opposite sides thereof or an aluminum bare material and which is interposed between the first member 34 and the second member 35 and is brazed to the first member 34 and the second member 35; and left and right end members 37 which are formed, through press work, from an aluminum brazing sheet having a brazing material layer on each of opposite sides thereof and which are brazed to left ends and right ends, respectively, of the first member 34, the second member 35, and the partition portion forming plate 36.

The first member 34 has the same structure as that of the first member 23 of the first header tank 2, and is disposed in a mirror-image relation with the first member 23. The first member 34 forms the convex portions 19 and 21 of the first intermediate header section 13 and the second intermediate header section 14, upper portions of the front and rear side walls of the first intermediate header section 13 and the second intermediate header section 14, and an upper portion of the connection section 15. A plurality of drain through holes 50 elongated in the left-right direction are formed in a flat portion 34a of the first member 34, which forms the upper portion of the connection section 15, such that the drain through holes 50 are spaced from one another in the left-right direction. The second member 35 has approximately the same structure as that of the second member 24 of the first header tank 2, and is disposed in a mirror-image relation with the second member 24. The second member 35 forms a bottom wall having an arcuate transverse cross section and connecting together upper end portions of the front and rear side walls of the first intermediate header section 13 and the second intermediate header section 14, lower portions of the front and rear side walls of the first intermediate header section 13 and the second intermediate header section 14, and a lower portion of the connection section 15. A plurality of drain through holes 56 elongated in the left-right direction are formed in a flat portion 35a of the second member 35, which forms the lower portion of the connection section 15, at positions corresponding to the positions of the drain through holes 50 of the first member 34.

The partition portion forming plate 36 has approximately the same structure as that of the partition portion forming plate 25 of the first header tank 2, and is disposed in a mirror-image relation with the partition portion forming plate 25. The partition portion forming plate 36 forms a front partition portion 38 which divides the interior of the first intermediate header section 13 into upper and lower spaces 13A and 13B, a rear partition portion 39 which divides the interior of the second intermediate header section 14 into upper and lower spaces 14A and 14B, and an intermediate portion (with respect to the vertical direction) of the connection section 15. A plurality of relative large rectangular communication holes 41 elongated in the left-right direction are formed in the front partition portion 38 at predetermined intervals in the left-right direction. Further, a plurality of circular communication holes (through holes) 42 are formed in a rear portion of the rear partition portion 39 at predetermined intervals in the left-right direction. Moreover, a plurality of drain through holes 57 elongated in the left-right direction are formed in a flat portion 36a of the partition portion forming plate 36, which forms the intermediate portion (with respect to the vertical direction) of the connection section 15, at positions corresponding to the positions of the drain through holes 50 and 56 of the first member 34 and the second member 35.

Provisional fixing claws 58, which are inserted into the drain through holes 57 and 50 of the partition portion forming plate 36 and the first member 34 from below, are integrally formed on the flat portion 35a of the second member 35 at one ends (right ends in the present embodiment) of at least a portion of the drain through holes 56. Distal end portions of the provisional fixing claws 58 are brazed to the partition portion forming plate 36 and the first member 34 in a state in which the distal end portions are bent rightward and bought into engagement with the upper surface of the first member 34. As in the case of the first header tank 2, before the first member 34, the second member 35, and the partition portion forming plate 36 are assembled together, the provisional fixing claws 58 extend straight. The first member 34, the second member 35, and the partition portion forming plate 36 are provisionally fixed together by means of assembling these members and bending the distal end portions of the provisional fixing claws 58. The straight provisional fixing claws before being bent are denoted by 58A.

In a portion of the second member 35 of the second header tank 3, which portion provides separation between the lower spaces 13B and 14B of the first and second intermediate header sections 13 and 14, a plurality of communication portions 43 for establishing communication between the lower spaces 13B and 14B of the first and second intermediate header sections 13 and 14 are provided at predetermined intervals in the left-right direction such that the communication portions 43 do not coincide with the drain through holes 50, 56, and 57. The communication portions 43 are formed when the second member 35 is formed, through press work, from an aluminum brazing sheet.

The left end member 37 closes the left end openings of the first intermediate header section 13 and the second intermediate header section 14, and the right end member 37 closes the right end openings of the first intermediate header section 13 and the second intermediate header section 14.

As shown in FIGS. 2, 4, 7, and 9, each of the heat exchange tubes 4 is composed of two rectangular metal plates 44 formed, through press work, from an aluminum brazing sheet. Specifically, each heat exchange tube 4 is formed by means of brazing front and rear side edge portions and central portions (with respect to the front-rear direction) of the metal plates 44 together over the entire lengths thereof. Thus, refrigerant flow spaces 45, which extend vertically and whose upper and lower ends are opened, are formed in each heat exchange tube 4 such that the refrigerant flow spaces 45 are separated from each other in the front-rear direction. The number of the refrigerant flow spaces 45 is two; i.e., a number equal to the number of the header sections 7 and 8 of the first header thank 2 and the number of the header sections 13 and 14 of the second header thank 3. Preferably, the two metal plates 44, which form each heat exchange tube 4, have a thickness of 0.25 mm or less. The refrigerant flow spaces 45 of each heat exchange tube 4 are provided as a result of forming outward swelled portions 48 of the metal plates 44, which extend over the entire length between brazed portions 46 of the heat exchange tube 4 where the front and rear side edge portions of the metal plates 44 are brazed together and a brazed portion 47 of the heat exchange tube 4 where the central portions of the metal plates 44 with respect to the front-rear direction are brazed together. Further, a corrugated inner fin 49 formed of aluminum is disposed to extend across both the refrigerant flow spaces 45 of the heat exchange tube 4 and brazed to the two metal plates 44. Preferably, the inner fin 49 has a thickness of 0.1 mm or less. The outward swelled portions 48 of each metal plate 44 of each heat exchange tube 4, which partially form the refrigerant flow spaces 45, have front and rear side walls 48a which incline outward with respect to the front-rear direction toward the center of the heat exchange tube 4 with respect to the thickness direction thereof (toward the other metal plate 44). Preferably, the angle θ formed between the front (rear) side wall 48a of each outward swelled portion 48 and the left or right side edge portion of the corresponding corrugate fin 5 is set to 25 to 40 degrees in consideration of easiness of drainage of condensed water generated on the surfaces of the heat exchange tubes 4 and the corrugate fins 5. Further, preferably, the distance between the front and rear refrigerant flow spaces 45 of each heat exchange tube 4 is set to 1.5 to 3.5 mm in consideration of easiness of drainage of condensed water generated on the surfaces of the heat exchange tubes 4 and the corrugate fins 5.

Upper and lower end portions of the brazed portions 46 of each heat exchange tube 4, where the front and rear side edge portions of the two metal plates 44 are brazed together, are cut and removed from the outer edges thereof with respect to the front-rear direction toward the upper and lower end surfaces, respectively. The cut portions are denoted by 51. Further, upper and lower end portions of the brazed portion 47 of each heat exchange tube 4, where the central portions of the two metal plates 44 with respect to the front-rear direction are brazed together, are made wider, with respect to the front-rear direction, than the remaining portions, whereby wide brazed portions 47a are formed. Cutouts 52 are formed in the wide brazed portions 47a from the outer ends thereof with respect to the vertical direction. Because of provision of the wide brazed portions 47a on the heat exchange tube 4, the upper and lower end portions of the refrigerant flow spaces 45 are narrower in width, with respect to the front-rear direction, than the remaining portions. Portions of the heat exchange tube 4 between the cut portions 51 of the brazed portions 46 and the cutout 52 of the wide brazed portions 47a correspond to the refrigerant flow spaces 45, and project outward with respect to the vertical direction from the remaining portions. Insertion portions 53 to be inserted into the tube insertion holes 18 and 22 of the first header tank 2 and the second header tank 3 are provided on the projecting portions. When the insertion portions 53 of the heat exchange tube 4 are inserted into the tube insertion holes 18 and 22 of the first header tank 2 and the second header tank 3, base or bottom portions of the cutouts 52 of the wide brazed portions 47a of the heat exchange tube 4 come into contact with the outer surfaces of the convex portions 16, 17, 19, and 21 of the first header tank 2 and the second header tank 3. The base or bottom portions serve as positioning portions 54 which position the corresponding end portions of the heat exchange tube 4.

Concave portions 55 are formed in the insertion portions 53 of the upper and lower end portions of the heat exchange tube 4, excluding opposite end portions thereof with respect to the front-rear direction, such that the concave portions 55 are concaved inward with respect to the longitudinal direction of the heat exchange tube 4. Each of the concave portions 55 of the insertion portions 53 of the heat exchange tube 4 has front and rear side portions 55a which incline inward with respect to the width direction of the heat exchange tube 4 toward the other end of the heat exchange tube 4, and a straight bottom side portion 55b which connects together inner end portions (with respect to the longitudinal direction of the heat exchange tube 4) of the front and rear side portions 55a and becomes parallel to the inner surface of the corresponding one of the connection walls 16c, 17c, 19c, and 21c of the convex portions 16, 17, 19, and 21 of the first header tank 2 and the second header tank 3. Preferably, the maximum distance D (as measured in the vertical direction) between the bottom side portion 55b of the concave portion 55 of each insertion portion 53 of the heat exchange tube 4 and the inner surface of the corresponding one of the connection walls 16c, 17c, 19c, and 21c of the convex portions 16, 17, 19, and 21 is 2.0 mm or less.

The corrugate fins 5 are shared by the front and rear refrigerant flow spaces 45 of the heat exchange tubes 4, and the width of the corrugate fins 5 with respect to the front-rear direction is approximately equal to the width of the heat exchange tubes 4.

In manufacture of the evaporator 1, component members thereof excluding the inlet pipe 11 and the outlet pipe 12 are assembled together, and the resultant assembly is subjected to batch brazing.

The evaporator 1, together with a compressor and a condenser serving as a refrigerant cooler, constitutes a refrigeration cycle which uses a chlorofluorocarbon-based refrigerant. This refrigeration cycle is installed in a vehicle, such as an automobile, as a car air conditioner.

In the evaporator 1 described above, while the compressor is ON, a two-phase refrigerant of vapor-liquid phase having passed through the compressor, the condenser, and an expansion valve enters the upper space 7A of the refrigerant inlet header section 7 of the first header tank 2 from the refrigerant inlet pipe 11 through the refrigerant passage 27a of the joint plate 27 and the refrigerant inlet 26a of the right end member 26. The refrigerant having entered the upper space 7A of the refrigerant inlet header section 7 flows leftward, enters the lower space 7B through the communication hole 31 and through the circular communication holes 32 of the front partition portion 28 of the partition portion forming plate 25, and then flows rightward within the lower space 7B. That is, within the upper space 7A, the refrigerant flows from the refrigerant-inlet-side end toward the other end, and, within the lower space 7B, the refrigerant flows in the direction opposite the flow direction within the upper space 7A.

Even when the flow rate of the refrigerant is high, the concave portion 55 of the insertion portion 53 of the upper end portion of each heat exchange tube 4 suppresses the upward bounding (i.e., upward deflection) of the refrigerant, which would otherwise occur when the refrigerant having entered from the refrigerant inlet into the upper space 7A of the refrigerant inlet header section 7 flows into the lower space 7B through the communication hole 31. Accordingly, the amount of the refrigerant flowing into heat exchange tubes 4 disposed in a central region of the refrigerant inlet header section 7 with respect to the longitudinal direction thereof increases, whereby the divided flow of the refrigerant into all the heat exchange tubes 4 connected to the refrigerant inlet header section 7 can be made uniform.

The refrigerant having entered the lower space 7B dividedly flows into the front refrigerant flow spaces 45 of the heat exchange tubes 4. The refrigerant having flowed into the front refrigerant flow spaces 45 of the heat exchange tubes 4 flows downward through the front refrigerant flow spaces 45 and enters the upper space 13A of the first intermediate header section 13 of the second header tank 3. The refrigerant having entered the upper space 13A of the first intermediate header section 13 enters the lower space 13B via the rectangular communication holes 41 of the front partition portion 38 of the partition portion forming plate 36. The refrigerant having entered the lower space 13B enters the lower space 14B of the second intermediate header section 14 through the communication portions 43.

The refrigerant having entered the lower space 14B of the second intermediate header section 14 enters the upper space 14A through the circular communication holes 42 of the rear partition portion 39 of the partition portion forming plate 36, and dividedly flows into the rear refrigerant flow spaces 45 of the heat exchange tubes 4.

The refrigerant having flowed into the rear refrigerant flow spaces 45 of the heat exchange tubes 4 flows upward and enters the lower space 8B of the refrigerant outlet header section 8, and then enters the upper space 8A via the oblong communication holes 33 of the rear partition portion 29 of the partition portion forming plate 25.

The refrigerant having entered the upper space 8A of the refrigerant outlet header section 8 flows rightward and then flows out into the refrigerant outlet pipe 12 through the refrigerant outlet 26b of the right end member 26 and the refrigerant passage 27b of the joint plate 27.

While flowing through the front and rear refrigerant flow spaces 45 of the rear heat exchange tubes 4, the refrigerant is subjected to heat exchange with air flowing through the air-passing clearances between the adjacent heat exchange tubes 4. Then, the refrigerant flows out from the evaporator 1 in a vapor phase.

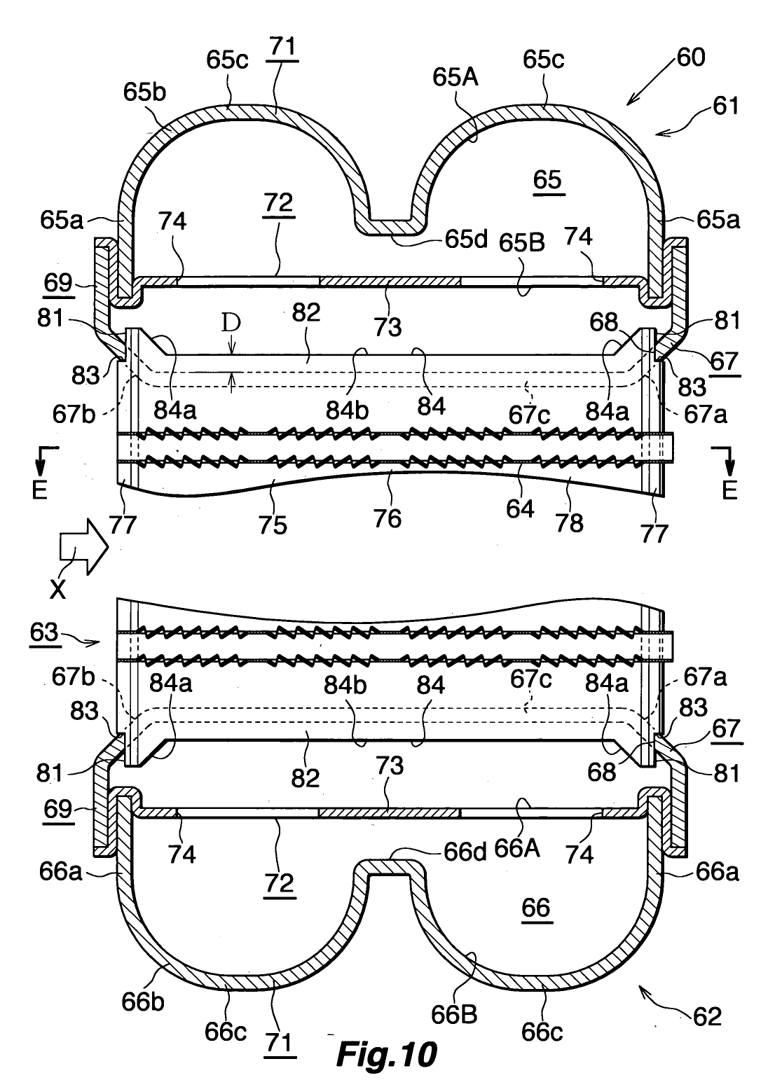

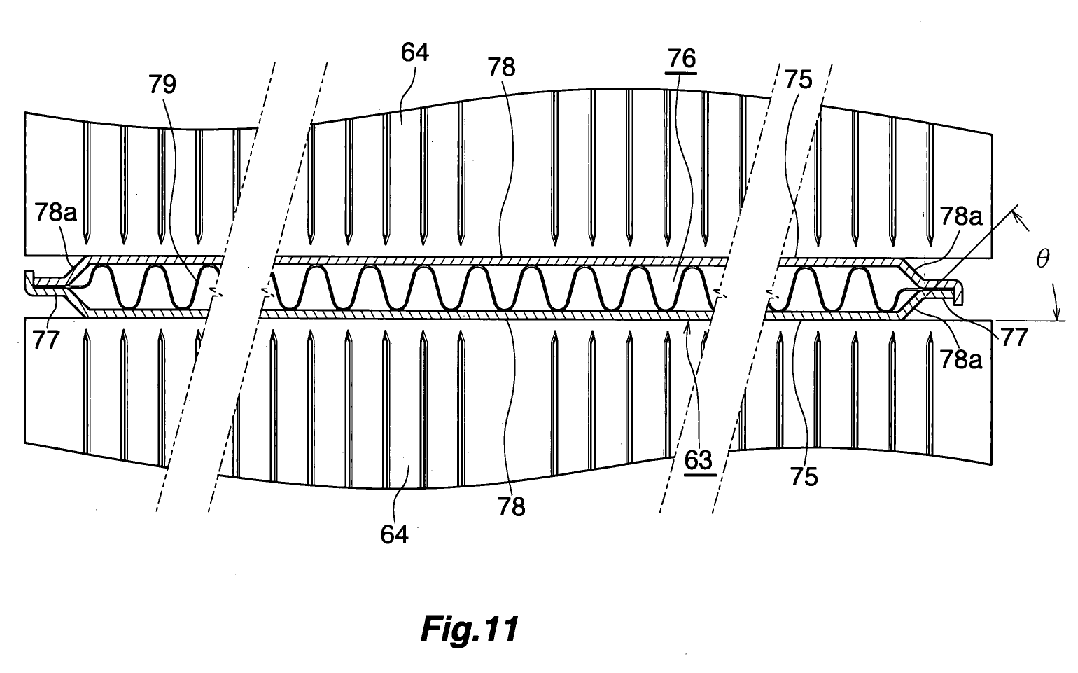

FIGS. 10 and 11 show another embodiment of the evaporator according to the present invention.

An evaporator 60 shown in FIGS. 10 and 11 includes a first header tank 61 and a second header tank 62 formed of aluminum and disposed apart from each other in the vertical direction such that they extend in the left-right direction; a plurality of flat heat exchange tubes 63 formed of aluminum and disposed between the two header tanks 61 and 62 such that their width direction coincides with the front-rear direction and they are spaced from one another in the left-right direction (the longitudinal direction of the header tanks 61 and 62); corrugated fins 64 made of aluminum, disposed in air-passing clearances between the adjacent heat exchange tubes 63 and externally of the left- and right-end heat exchange tubes 63, and brazed to the heat exchange tubes 63; and side plates (not shown) made of aluminum, disposed externally of the left- and right-end corrugated fins 64 and brazed to the corrugated fins 64.

The entire first header tank 61 serves as a refrigerant inlet header section 65, and the entire second header tank 62 serves as a refrigerant outlet header section 66. A refrigerant inlet pipe (not shown) made of aluminum is connected to the refrigerant inlet header section 65 of the first header tank 61. Similarly, a refrigerant outlet pipe (not shown) made of aluminum is connected to the refrigerant outlet header section 66 of the second header tank 62.

At a lower portion (a portion facing the second header tank 62) of the refrigerant inlet header section 65 of the first header tank 61, a convex portion 67 which projects downward (toward the second header tank 62) is formed over the entire length of the first header tank 61. The convex portion 67 of the refrigerant inlet header section 65 has front and rear side walls 67a and 67b which incline inward with respect to the front-rear direction (inward with respect to the width direction of the heat exchange tubes 63) toward the lower side (toward the second header tank 62), and a horizontal flat connection wall 67c which connects the distal ends (lower ends) of the front and rear side walls 67a and 67b together. A plurality of tube insertion holes 68, which extend in the front-rear direction and into which upper end portions of the heat exchange tubes 63 are inserted, are formed in the refrigerant inlet header section 65 such that they extend from the front side wall 67a to the rear side wall 67b of the convex portion 67.

The first header tank 61 is composed of a plate-like first member 69 which is formed, through press work, from an aluminum brazing sheet having a brazing material layer on each of opposite sides thereof and to which all the heat exchange tubes 63 are connected; a second member 71 which is formed, through press work, from an aluminum brazing sheet having a brazing material layer on each of opposite sides thereof and which covers the upper side (the side opposite the heat exchange tubes 63) of the first member 69; a flat partition portion forming plate 72 which is formed, through press work, from an aluminum brazing sheet having a brazing material layer on each of opposite sides thereof or an aluminum bare material and which is interposed between the first member 69 and the second member 71 and is brazed to the first member 69 and the second member 71; and left and right end members (not shown) which are formed, through press work, from an aluminum brazing sheet having a brazing material layer on each of opposite sides thereof and which are brazed to left ends and right ends, respectively, of the first member 69, the second member 71, and the partition portion forming plate 72.

The first member 69 forms the convex portion 67 of the refrigerant inlet header section 65, and lower portions of the vertical front and rear side walls 65a of the refrigerant inlet header section 65. The second member 71 forms a top wall 65b connecting together upper end portions of the front and rear side walls 65a of the refrigerant inlet header section 65, and upper portions of the front and rear side walls 65a of the refrigerant inlet header section 65. The top wall 65b, which connects together upper end portions of the front and rear side walls 65a of the refrigerant inlet header section 65, includes two upward swelled portions 65c which are provided apart from each other in the front-rear direction, and each have a generally U-shaped transverse cross section such that the swelled portions 65c are opened downward and project upward; and a connection section 65d, which integrally connects together the inner walls of the upward swelled portions 65c with respect to the front-rear direction. The partition portion forming plate 72 has a partition portion 73 (partition member) which divides the interior of the refrigerant inlet header section 65 into upper and lower spaces 65A and 65B. A plurality of relatively large rectangular communication holes 74 elongated in the left-right direction are formed, at predetermined intervals in the left-right directions, in each of front and rear portions of the partition portion 73 of the partition portion forming plate 72. The left and right end members close the left and right end openings of the refrigerant inlet header section 65. A refrigerant inlet is formed in a portion (facing the upper space 65A) of the left end member or the right end member.

The second header tank 62 has the same structure as the first header tank 61, and is disposed in a mirror-image relation with the first header tank 61. Therefore, portions identical to those of the first header tank 61 are denoted by the same reference numerals. Accordingly, at an upper portion (a portion facing the first header tank 61) of the refrigerant outlet header section 66 of the second header tank 62, a convex portion 67 which projects upward (toward the first header tank 61) is formed over the entire length of the second header tank 62. A bottom wall 66b of the second member 71 of the refrigerant outlet header section 66, which connects lower end portions of the front and rear side walls 66a of the refrigerant outlet header section 66 includes two downward swelled portions 66c which are provided apart from each other in the front-rear direction, and each have a generally U-shaped transverse cross section such that the swelled portions 66c are opened upward and project downward; and a connection section 66d, which integrally connects together the inner walls of the downward swelled portions 66c with respect to the front-rear direction. Further, the interior of the refrigerant outlet header section 66 is divided into upper and lower spaces 66A and 66B by the partition portion 73 of the partition portion forming plate 72. Moreover, a refrigerant outlet is formed in a portion (facing the lower space 66B) of the left end member or the right end member.

Each of the heat exchange tubes 63 is composed of two rectangular metal plates 75 formed, through press work, from an aluminum brazing sheet. Specifically, each heat exchange tube 63 is formed by means of brazing front and rear side edge portions of the metal plates 75 together over the entire lengths thereof. Thus, a refrigerant flow space 76, which extends vertically and whose upper and lower ends are opened, is formed in each heat exchange tube 63. The number of the refrigerant flow space 76 is one; i.e., a number equal to the number of the header sections of the first header thank 61 and the number of the header sections of the second header thank 62. Preferably, the two metal plates 75, which form each heat exchange tube 63, have a thickness of 0.25 mm or less. The refrigerant flow space 76 of each heat exchange tube 63 is provided as a result of forming outward swelled portions 78 of the metal plates 75, which extend over the entire length between brazed portions 77 of the heat exchange tube 63 where the front and rear side edge portions of the metal plates 75 are brazed together. Further, a corrugated inner fins 79 formed of aluminum is disposed within the refrigerant flow space 76 of the heat exchange tube 63 and brazed to the two metal plates 75. Preferably, the inner fin 79 has a thickness of 0.1 mm or less. The outward swelled portion 78 of each metal plate 75 of each heat exchange tube 63, which partially forms the refrigerant flow space 76, has front and rear side walls 78a which incline outward with respect to the front-rear direction toward the center of the heat exchange tube 63 with respect to the thickness direction thereof (toward the other metal plate 75). Preferably, the angle θ formed between the front (rear) side wall 78a of the outward swelled portion 78 and the left or right side edge portion of the corresponding corrugate fin 64 is set to 25 to 40 degrees in consideration of easiness of drainage of condensed water generated on the surfaces of the heat exchange tubes 63 and the corrugate fins 64.

Upper and lower end portions of the brazed portions 77 of each heat exchange tube 63, where the front and rear side edge portions of the two metal plates 75 are brazed together, are cut and removed from the outer edges thereof with respect to the front-rear direction toward the upper and lower end surfaces, respectively. The cut portions are denoted by 81. Portions of the heat exchange tube 63 between the cut portions 81 of the brazed portions 77 correspond to the refrigerant flow space 76 and project outward with respect to the vertical direction from the remaining portions. Insertion portions 82 to be inserted into the tube insertion holes 68 of the first header tank 61 and the second header tank 62 are provided on the projecting portions. When the insertion portions 82 of the heat exchange tube 63 are inserted into the tube insertion holes 68 of the first header tank 61 and the second header tank 62, inner end portions (with respect to the vertical direction) of the cut portions 81 of the brazed portions 77 of the heat exchange tube 63 come into contact with the outer surfaces of the convex portions 67 of the first header tank 61 and the second header tank 62. That is, the inner end portions of the cut portions 81 with respect to the vertical direction serve as positioning portions 83 for positioning the end portions of the heat exchange tube 63.

Concave portions 84 are formed in the insertion portions 82 of the upper and lower end portions of the heat exchange tube 63, excluding opposite end portions thereof with respect to the front-rear direction, such that the concave portions 84 are concaved inward with respect to the longitudinal direction of the heat exchange tube 63. Each of the concave portions 84 of the insertion portions 82 of the heat exchange tube 63 has front and rear side portions 84a which incline inward with respect to the width direction of the heat exchange tube 63 toward the other end of the heat exchange tube 63, and a straight bottom side portion 84b which connects together inner end portions (with respect to the longitudinal direction of the heat exchange tube 63) of the front and rear side portions 84a and becomes parallel to the inner surface of the corresponding one of the connection walls 67c of the convex portions 67 of the first header tank 61 and the second header tank 62. Preferably, the maximum distance D (as measured in the vertical direction) between the bottom side portion 84b of the concave portion 84 of each insertion portion 82 of the heat exchange tube 63 and the inner surface of the corresponding one of the connection walls 67c of the convex portions 67 is 2.0 mm or less.

The evaporator 60, together with a compressor and a condenser serving as a refrigerant cooler, constitutes a refrigeration cycle which uses a chlorofluorocarbon-based refrigerant. This refrigeration cycle is installed in a vehicle, such as an automobile, as a car air conditioner.

In the evaporator 60 described above, while the compressor is ON, a two-phase refrigerant of vapor-liquid phase having passed through the compressor, the condenser, and an expansion valve enters the refrigerant inlet header section 65 of the first header tank 61 from the refrigerant inlet of the left or right end member, and dividedly flows into the refrigerant flow spaces 76 of the heat exchange tubes 63.

Even when the flow rate of the refrigerant is high, the concave portion 84 of the insertion portion 82 of the upper end portion of each heat exchange tube 63 increases the cross sectional area of the refrigerant flow channel within the refrigerant inlet header section 65, whereby the flow velocity of the refrigerant decreases. Therefore, it is possible to prevent the refrigerant having flowed from the refrigerant inlet from flowing to the end portion opposite the refrigerant inlet due to inertia. Accordingly, the amount of the refrigerant flowing into heat exchange tubes 63 disposed on the side toward the refrigerant inlet of the refrigerant inlet header section 65 increases, whereby the divided flow of the refrigerant into all the heat exchange tubes 63 connected to the refrigerant inlet header section 65 can be made uniform.

The refrigerant having flowed into the front refrigerant flow spaces 76 of the heat exchange tubes 63 flows downward through the front refrigerant flow spaces 76 and enters the refrigerant outlet header section 66 of the second header tank 62, and flows out into the refrigerant outlet pipe through the refrigerant outlet of the right or left end member.

While flowing through the front and rear refrigerant flow spaces 76 of the rear heat exchange tubes 63, the refrigerant is subjected to heat exchange with air flowing through the air-passing clearances between the adjacent heat exchange tubes 63. Then, the refrigerant flows out from the evaporator 60 in a vapor phase.

In some cases, the evaporator 60 shown in FIGS. 10 and 11 is configured in such a manner that the interior of the first header tank 61 is divided into left and right spaces by means of a partition member provided at the center with respect to the left-right direction. In such a case, one space is used as a refrigerant inlet header section, and the other space is used as a refrigerant outlet header section. Further, the entirety of the second header tank 62 is used as an intermediate header section. Thus, a refrigerant inlet is formed in the refrigerant inlet header section of the first header tank 61, and a refrigerant outlet is formed in the refrigerant outlet header section of the first header tank 61.

What is claimed is:

1. An evaporator comprising a pair of header tanks disposed apart from each other in a vertical direction, and a plurality of flat heat exchange tubes disposed between the two header tanks such that the width direction of the heat exchange tubes coincides with a front-rear direction and the heat exchange tubes are spaced from one another in a longitudinal direction of the header tanks, each of the header tanks including at least one header section which extends in the longitudinal direction of the header tanks, and opposite end portions of the heat exchange tubes being inserted into respective tube insertion holes formed in the header sections of the header tanks and brazed to the header tanks, wherein
each heat exchange tube is composed of two press-worked rectangular metal plates joined together in a stacked condition;
each heat exchange tube includes at least one refrigerant flow space which extends in the vertical direction and whose upper and lower ends are opened, the refrigerant flow space being formed by means of swelling outward at least one of the metal plates of the heat exchange tube;
insertion portions to be inserted into the header sections of the header tanks via the tube insertion holes are provided on upper and lower end portions of each heat exchange tube at positions corresponding to the refrigerant flow space; and
a concave portion is formed in the insertion portion, excluding opposite ends thereof with respect to the front-rear direction, of at least the upper end portion of each heat exchange tube, the concave portion being concaved inward with respect to a longitudinal direction of the heat exchange tube.

2. An evaporator according to claim 1, wherein the header section of at least the upper header tank includes a convex portion which projects toward the other header tank and extends over the entire length of the upper header tank, and the convex portion has tube insertion holes into which the insertion portions of the heat exchange tubes are inserted.

3. An evaporator according to claim 2, wherein the convex portion of the header section of the upper header tank includes front and rear side walls which incline inward with respect to the width direction of the heat exchange tube toward the other header tank, and a flat connection wall which connects together distal ends of the front and rear side walls; and the tube insertion holes extend from the front side wall to the rear side wall of the convex portion.

4. An evaporator according to claim 3, wherein the concave portion of each insertion portion of each heat exchange tube includes front and rear side portions which incline inward with respect to the width direction of the heat exchange tube toward the other end of the heat exchange tube, and a straight bottom side portion which connects together inner end portions of the front and rear side portions with respect to the longitudinal direction of the heat exchange tube and which expends in parallel to an inner surface of the connection wall of the convex portion of the corresponding header section.

5. An evaporator according to claim 4, wherein the maximum distance, as measured in the vertical direction, between the bottom side portion of the concave portion of each insertion portion of each heat exchange tube and the inner surface of the connection wall of the convex portion of the corresponding header section is 2.0 mm or less.

6. An evaporator according to claim 1, wherein each header tank includes a plurality of header sections juxtaposed in the front-rear direction; each heat exchange tube includes a plurality of refrigerant flow spaces separated from one another in the front-rear direction, the number of the refrigerant flow spaces being equal to the number of the header sections; and positioning portions which come into engagement with outer surfaces of the upper and lower header tanks so as to position the upper and lower end portions of each heat exchange tube are provided on the upper and lower ends of the heat exchange tube to be located between the adjacent refrigerant flow spaces.

7. An evaporator according to claim 1, wherein each header tank includes a single header section; each heat exchange tube includes a singe refrigerant flow space; and positioning portions which come into engagement with outer surfaces of the upper and lower header tanks so as to position the upper and lower end portions of each heat exchange tube are provided on the upper and lower ends of the heat exchange tube to be located on the front and rear sides, respectively, of the refrigerant flow space.

8. An evaporator according to claim 1, wherein each of the two metal plates of each heat exchange tube has a thickness of 0.25 mm or less.

9. An evaporator according to claim 1, wherein a corrugated inner fin is disposed within the refrigerant flow space of each heat exchange tube and brazed to the two metal plates, and the inner fin has a thickness of 0.1 mm or less.

10. An evaporator according to claim 1, wherein the upper header tank includes a refrigerant inlet header section having a refrigerant inlet at one end thereof, and refrigerant flows within the refrigerant inlet header section from a refrigerant-inlet-side end toward the other end.

11. An evaporator according to claim 1, wherein the upper header tank includes a refrigerant inlet header section having a refrigerant inlet at one end thereof; the interior of the refrigerant inlet header section is divided by means of a partition member into an upper space into which refrigerant flows via the refrigerant inlet and an lower space which the heat exchange tubes face; the upper and lower spaces of the refrigerant inlet header section are connected with each other via a communication portion at an end opposite the refrigerant inlet; and, in the upper space, the refrigerant flows from a refrigerant-inlet-side end toward the other end, and, in the lower space, the refrigerant flows in a direction opposite the flow direction of the refrigerant within the upper space.
